(19) United States
(12) Patent Application Publication
(10) Pub. No.: US 2014/0253957 A1
(43) Pub. Date: Sep. 11, 2014

(54) SYSTEMS AND METHODS FOR EXTENDING CAPABILITY OF AN IMAGING DEVICE

(71) Applicant: DELL PRODUCTS L.P., Round Rock, TX (US)

(72) Inventors: Bee June Tye, Singapore (SG); Song Poh Chai, Singapore (SG); Vivek Chopra, Singapore (SG); Hui Li Lee, Singapore (SG); Pong Fei Tan, Singapore (SG); Natarajan Annamalai, Singapore (SG)

(73) Assignee: DELL PRODUCTS L.P., Round Rock, TX (US)

(21) Appl. No.: 13/793,291

(22) Filed: Mar. 11, 2013

(51) Int. Cl. G06F 3/12

(52) U.S. Cl. CPC G06F 3/1224
USPC 358/1.15

(57) ABSTRACT

In accordance with embodiments of the present disclosure, a document workflow server application may comprise one or more instructions embodied in computer-readable media. The document workflow server application may be configured to, when executed by a processor of a document workflow server receive from an imaging device communicatively coupled to the document workflow server via the Internet a user selection to perform a document service and in response to the user selection, perform the document service.

### TECHNICAL FIELD

The present disclosure relates in general to information handling systems, and more particularly to extending the operational capabilities of imaging devices.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Imaging devices, for example printers, copiers, and facsimile machines, are often used alone and/or in combination with information handling systems to print latent images (e.g., text and/or pictures) on a recording medium (e.g., paper, transparencies, and/or any other suitable medium) using an imaging medium (e.g., toner, ink, and/or other suitable medium). Modern imaging devices may include, without limitation, toner-based imaging devices and inkjet imaging apparatuses. In addition, an imaging device may comprise a digital document scanner configured to optically scan an image, printed text, handwriting, and/or an object, and convert such optical scan to a digital image.

Many modern imaging devices may include “multi-function” imaging devices, sometimes referred to as “multi-function printers” which combine functionality of multiple imaging devices into a single device. For example, a multi-function imaging device may be configured with functionality for printing, copying, transmitting facsimiles, and/or document scanning.

Multi-function imaging devices designed for small-to-medium businesses often include limited hardware resources and processing capability in order to maintain relatively low cost. For example, such multi-function imaging devices may lack resources to run resource-intensive applications such as optical character recognition, document format conversion, and other tasks that might be available on more expensive multi-function imaging devices. Thus, many printing and scanning tasks may remain dependent on computing devices such as personal computers to perform, oftentimes manually, resource-intensive tasks in multiple steps. Such limited capabilities result in numerous challenges, including limited scan file formats, limited print file formats, and limited integration with other extensible workflows requiring higher processing capabilities, for example searching documents from user-subscribed storage repositories.

### SUMMARY

In accordance with the teachings of the present disclosure, the disadvantages and problems associated with cost-effectively increasing capabilities of an imaging device may be substantially reduced or eliminated.

In accordance with embodiments of the present disclosure, a document workflow server application may comprise one or more instructions embodied in computer-readable media. The document workflow server application may be configured to, when executed by a processor of a document workflow server receive from an imaging device communicatively coupled to the document workflow server via the Internet a user selection to perform a document service and in response to the user selection, perform the document service.

In accordance with these and other embodiments of the present disclosure, a document workflow client application may comprise one or more instructions embodied in computer-readable media. The document workflow client application may be configured to, when executed by a processor of an imaging device receive from a user interface of the imaging device a user selection to perform a document service and in response to the user selection, communicate the user selection to a document workflow server communicatively coupled to the imaging device via the Internet, wherein communication of the user selection causes the document workflow server to perform the document service.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for extending the functionality of an imaging device, in accordance with embodiments of the present disclosure; and

FIGS. 2A and 2B illustrate a method for extending the functionality of an imaging device, in accordance with embodiments of the present disclosure.

### DETAILED DESCRIPTION

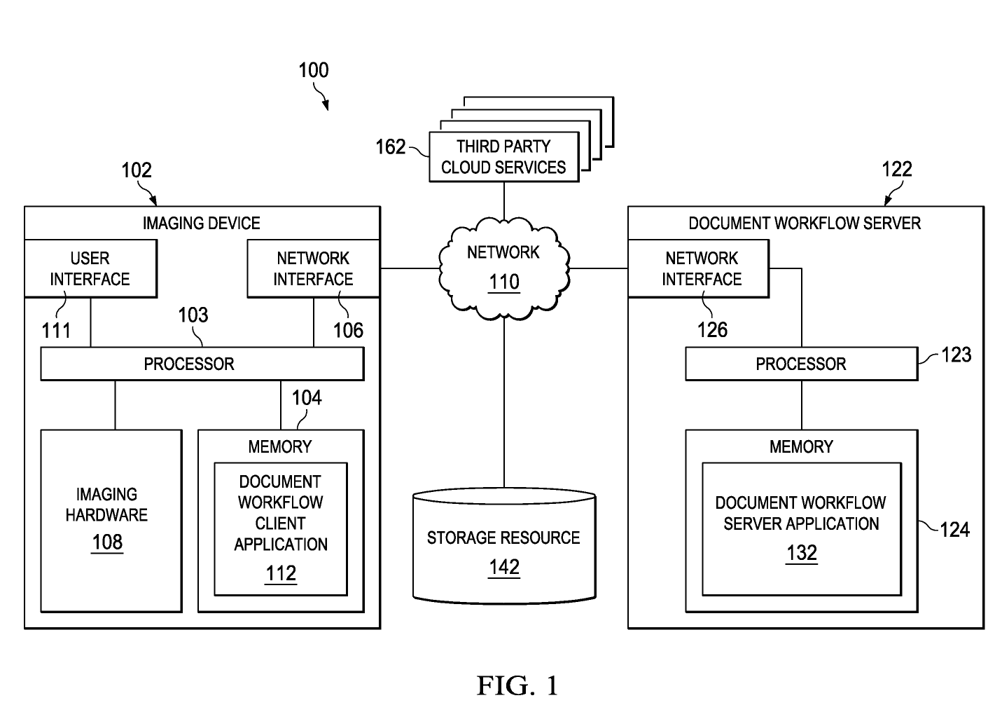

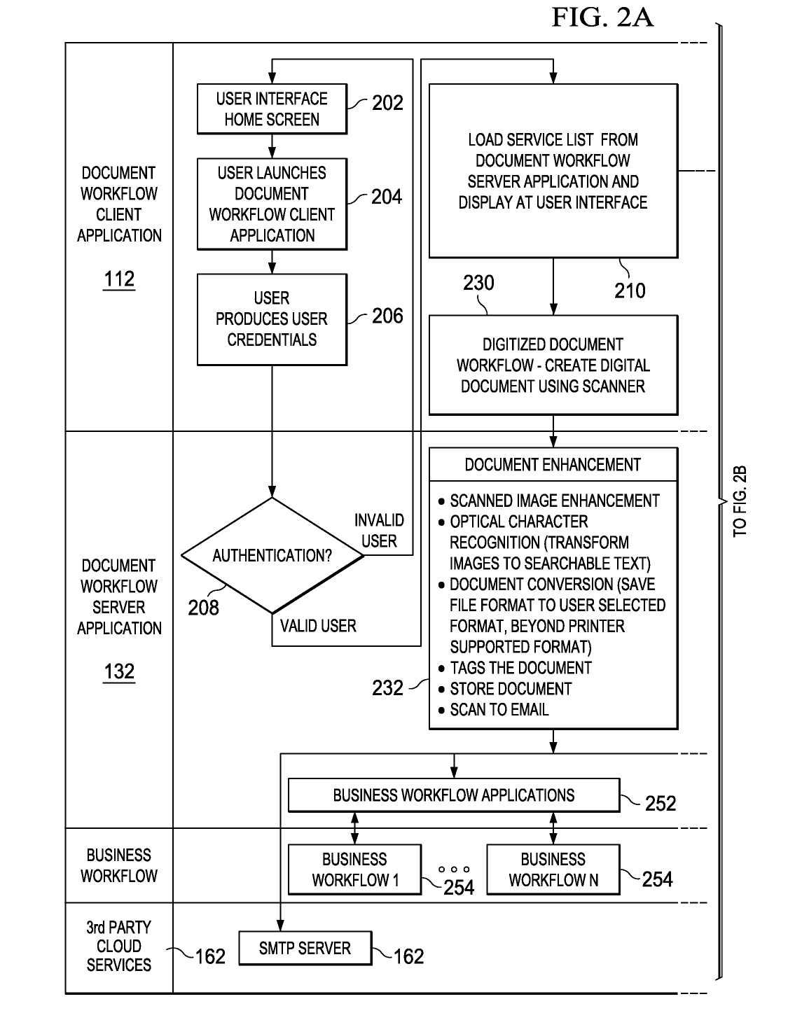

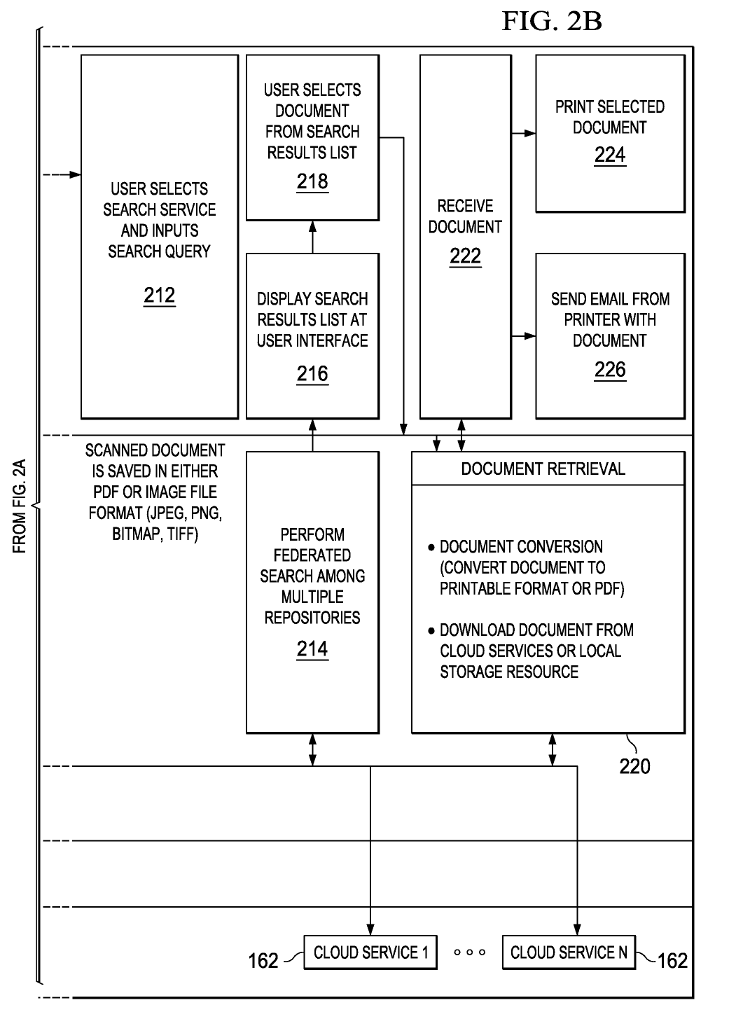

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, computer-readable media, memories, I/O devices and/or interfaces, storage resources, network interfaces, motherboards, integrated circuit packages; electro-mechanical devices (e.g., air movers), displays, and power supplies.

FIG. 1 illustrates a system 100 for extending the functionality of an imaging device 102, in accordance with embodiments of the present disclosure. As shown in FIG. 1, system 100 may include an imaging device 102, a document workflow server 122, a storage resource 142, one or more third-party cloud services 162, and a network 110 communicatively coupling imaging device 102, document workflow server 122, storage resource 142, and/or the one or more third-party cloud services 162 to one another.

Imaging device 102 may include any system, device, or apparatus configured to print latent images (e.g., text and/or pictures) on a recording medium (e.g., paper, transparencies, and/or any other suitable medium) using an imaging medium (e.g., toner, ink, and/or other suitable medium), send and/or receive facsimile transmissions, and/or digitally scan documents. Thus, imaging device 102 may perform some or all of the functionality traditionally associated with printers, copiers, facsimile machines, and/or scanners. As depicted in FIG. 1, imaging device 102 may include a processor 103, a memory 104 communicatively coupled to processor 103, a network interface 106 communicatively coupled to processor 103, imaging hardware 108 communicatively coupled to processor 103, and a user interface 111 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of imaging device 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to imaging device 102 is turned off.

As shown in FIG. 1, memory 104 may have stored thereon document workflow client application 112. Document workflow client application 112 may include any system, device, or apparatus configured to interact with document workflow server 122 and information handling resources of imaging device 102 (e.g., imaging hardware 108, user interface 111) in order to facilitate performance of document workflow services for imaging device 102 by documents workflow server 122, as described in greater detail below. Accordingly, among the functionality of document workflow client application 112 may be to interface with user interface 111 to receive user input and to display information to user interface 111. Document workflow client application 112 may also be configured for communications (e.g., via the World Wide Web/Internet) with document workflow server 122, including authenticating imaging device 102 for use with document workflow server 122 and/or third-party cloud services and synchronizing user-configured imaging device settings of imaging device 102 with document workflow server 122. Document workflow client application 112 may further be configured to interface with imaging hardware 108 to access core functionalities of imaging device 102 (e.g., print, copy, scan, fax, etc.), access any file system and/or memory resources internal to imaging device 102, and/or handle events and notifications associated with imaging device 102. In some embodiments, document workflow client application 112 may be implemented as a program of instructions that may be read by and executed on processor 103 to carry out the functionality of document workflow client application 112.

Network interface 106 may comprise any suitable system, apparatus, or device operable to serve as an interface between imaging device 102 and network 110. Network interface 106 may enable imaging device 102 to communicate using any suitable transmission protocol and/or standard, including without limitation, all transmission protocols and/or standards enumerated below with respect to the discussion of network 110. In these and other embodiments, network interface 106 may comprise a network interface card, or “NIC.”

Imaging hardware 108 may include any and all physical elements for carrying out the core functionality of imaging device 102, including printing documents, copying documents, scanning documents, and transmitting facsimiles. The structure and functionality of such imaging hardware 108 is well known in the art, and as such, is not discussed at length in this disclosure.

User interface 111 may comprise any instrumentality or aggregation of instrumentalities by which a user may interact with imaging device 102. For example, user interface 111 may permit a user to input data and/or instructions into user imaging device 102, and/or otherwise manipulate imaging device 102 and its associated components. User interface 111 may also permit imaging device 102 to communicate data to a user, e.g., by way of a display device.

In addition to processor 103, memory 104, network interface 106, imaging hardware 108, and/or user interface 111, imaging device 102 may include one or more other information handling resources.

Network 110 may be a network and/or fabric configured to couple imaging device 102, document workflow server 122, storage resource 142, and/or third-party cloud services 162 to each other and/or one or more other information handling systems. In these and other embodiments, network 110 may include a communication infrastructure, which provides physical connections, and a management layer, which organizes the physical connections and information handling systems communicatively coupled to network 110. Network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 110 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

Document workflow server 122 may generally comprise an information handling system. In some embodiments, document workflow server 122 may be a server. As depicted in FIG. 1, document workflow server 122 may include a processor 123, a memory 124 communicatively coupled to processor 123, and a network interface 126 communicatively coupled to processor 123.

Processor 123 may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 123 may interpret and/or execute program instructions and/or process data stored in memory 124 and/or another component of document workflow server 122.

Memory 124 may be communicatively coupled to processor 123 and may include any system, device, or apparatus configured to retain program instructions and/or data for a period of time (e.g., computer-readable media). Memory 124 may include RAM, EEPROM, a PCMCIA card, flash memory, magnetic storage, opto-magnetic storage, or any suitable selection and/or array of volatile or non-volatile memory that retains data after power to document workflow server 122 is turned off.

As shown in FIG. 1, memory 124 may have stored thereon document workflow server application 132. Document workflow server application 132 may include any system, device, or apparatus configured to interact with document workflow client application 112 of imaging device 102, storage resource 142, and third-party cloud services 162 in order to facilitate performance of document workflow services for imaging device 102 by document workflow server 122, as described in greater detail below. Accordingly, among the functionality of document workflow server application 132 may be to maintain user account administration for imaging device 102, including administration of user access, maintaining entitlement to specific services associated with imaging device 102 or a user thereof, and/or billing and accounting for services associated with imaging device 102 and/or a user thereof. In addition, document workflow server application 132 may be configured to perform document management for files associated with imaging device 102, including, for example, document capture, analysis (e.g., based on document metadata), classification, format conversion (e.g., conversion of documents to formats printable on imaging device 102), and searching and indexing of documents stored on storage resource 142 and/or third-party cloud services 162. Further, document workflow server application 132 may be configured to perform job management tasks for handling distribution, monitoring, and tracking of jobs associated with imaging device 102, including, for example, enabling email capability to the extent not supported by imaging device 102, communicating alerts and another notifications regarding such jobs, and/or metering job usage for purposes of billing, accounting, analytics, and/or auditing. Moreover, document workflow server application 132 may perform security tasks, including data encryption and maintaining an audit trail of documents. Also, document workflow server application 132 may be an open platform allowing for custom development by third-party independent software vendors to develop applications to interface with document workflow server application 132 (e.g., to enable custom business workflow solutions). In some embodiments, document workflow server application 132 may be implemented as a program of instructions that may be read by and executed on processor 123 to carry out the functionality of document workflow server application 132.

Network interface 126 may comprise any suitable system, apparatus, or device operable to serve as an interface between document workflow server 122 and network 110. Network interface 126 may enable document workflow server 122 to communicate using any suitable transmission protocol and/or standard, including any of the protocols and/or standards described above with respect to network 110. In these and other embodiments, network interface 126 may comprise a NIC.

In addition to processor 123, memory 124, and network interface 126, document workflow server 122 may include one or more other information handling resources.

Storage resource 142 may include any suitable collection of computer-readable media for storing of data associated with document workflow server 122. In some embodiments, input/output operations associated with data stored on storage resource 142 may be managed by document workflow server application 132. Accordingly, storage resource 142 may serve as a data store for documents associated with or accessible to imaging device 102.

Third-party cloud services 162 may include any suitable service for maintaining documents associated with or accessible to imaging device 102, or performing a service with respect to such documents to modify, transform, or reformat a document. For example, a third-party cloud service 162 may comprise a search engine. As another example, a third-party cloud service 162 may comprise an image hosting, video hosting, and/or photo sharing website. As a further example, a third-party cloud service 162 may include a file storage and synchronization service. Subscriptions of an imaging device 102 of a user thereof to third-party cloud services 162 may be maintained by document workflow server application 132, such that by authenticating a user on imaging device 102, document workflow server application 132 may access such subscriptions to perform services for imaging device 102.

FIGS. 2A and 2B (which may be collectively referred to herein as “FIG. 2” illustrates a method 200 for extending the functionality of an imaging device (e.g., imaging device 102), in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, document workflow client application 112 may display a home screen to user interface 111 of imaging device 102. At step 204, a user interacting with user interface 111 may choose to launch document workflow client application 112 and at step 206, may input user credentials (e.g., username and password) to document workflow client application 112.

At step 208, document workflow server application 132 may receive the user credentials from document workflow client application 112 and authenticate the user credentials. If authenticated, method 200 may proceed to step 210. Otherwise, method 200 may proceed again to step 202.

At step 210, document workflow client application 112 may retrieve a list of available services from document workflow server application 132 and display such list of services to user interface 111, and a user may select a desired service. Among the services that may be listed includes a search service whereby a user may search for a document (e.g., on storage resource 142 and/or third-party cloud services 162) and a document digitization workflow whereby a scanned document is digitized by imaging device 102 and further processed by document workflow server application 132.

At step 212, in response to a user selection of a search service, document workflow client application 112 may communicate such selection along with the user's search query to document workflow server application 132. At step 214, document workflow server application 132 may perform a federated search among multiple document repositories and return to document workflow client application 112 a list of results (e.g., ranked by relevance to the search query). Document workflow server application 132 may perform the federated search across document repositories associated with imaging device 102 and/or the authenticated user thereof, including storage resource 142 and/or third-party cloud services 162 to which imaging device 102 and/or the authenticated user thereof is subscribed. In some embodiments, document workflow server application 132 may also interface with business workflow applications 252 created for use with document workflow server application 132 by a user or administrator of imaging device 102 and/or third-party independent software vendors, such that the federated search may also be performed across one or more business workflows 254 associated with a business of the imaging device 102 and/or the authenticated user.

At step 216, document workflow client application 112 may receive search results and display such search results at user interface 111. At step 218, the user may select a document from the list of search results, and document workflow client application 112 may communicate the selection to document workflow server application 132.

At step 220, document workflow server application 132 may retrieve the selected document from the document repository in which it is stored. As part of the retrieval, document workflow server application 132 may convert the document to another format (e.g., into a format printable by imaging device 102 or a format selected for sending via an email, such as a PDF). At step 222, document workflow client application 112 may receive the retrieved document.

Once received, document workflow client application 112 may perform one or more operations on the document, including printing the selected document, as shown at step 224, or sending an email including the document, as shown at step 226.

At step 230, in response to a user selection of a document digitization service, document workflow client application 112 may create a digital image for a scanned document and communicate such digital image in a native file format of imaging device 102 (e.g., PDF, JPEG, PNG, bitmap, TIFF) to document workflow server application 132.

At step 232, document workflow server application 132 may receive the digital image and perform one or more document enhancement operations on it. For example, document workflow server application 132 may optically enhance the scanned image (e.g., to reduce blur or improve resolution), may perform optical character recognition (e.g., to transform scanned image to searchable text), may convert the document to another file format (e.g., save file to a user-selected format beyond a native file type or supported file type of imaging device 102), tag the document (e.g., add metadata), store the document (e.g., to storage resource 142 and/or a third-party cloud service 162 for which imaging device 102 and/or the authenticated user thereof is subscribed); and/or communicate the document via email (e.g., via a Simple Mail Transfer Protocol server 162 to which document workflow server 122 is communicatively coupled, thus permitted scan-and-email from an imaging device 102 not configured to send email on its own).

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. A document workflow server application comprising one or more instructions embodied in computer-readable media, the document workflow server application configured to, when executed by a processor of a document workflow server:
receive from an imaging device communicatively coupled to the document workflow server via the Internet a user selection to perform a document service; and
in response to the user selection, perform the document service.

2. The document workflow server application of claim 1, wherein the user selection is a user selection to perform a document search and the document workflow server application is further configured to, in response to the user selection:
perform a federated document search among multiple storage repositories; and
communicate search results to the imaging device.

3. The document workflow server application of claim 2, wherein the multiple storage repositories comprise at least one third-party cloud service.

4. The document workflow server application of claim 2, further configured to:
receive a user selection of a document from the search results; and
in response to the user selection of the document, retrieve the document from a storage repository on which it is stored and communicate the document to the imaging device.

5. The document workflow server application of claim 4, further configured to convert the document from a first file format in which it is stored on the storage repository to a second file format.

6. The document workflow server application of claim 5, the second file format comprising a file format for which the imaging device can print the document.

7. The document workflow server application of claim 1, wherein the user selection is a user selection to digitize a scanned document and the document workflow server application is further configured to, in response to the user selection:
receive the scanned document from the imaging device; and
perform one or more document enhancement operations on the document.

8. The document workflow server application of claim 7, wherein the one or more document enhancement operations comprises one or more of:
optical enhancement of the document;
optical character recognition of the document;
conversion of the document from a first file format in which it is created on the imaging device to a second file format; and
tagging the document with metadata.

9. The document workflow server application of claim 7, wherein:
the imaging device is not configured to send an electronic mail from the imaging device; and
the one or more document enhancement operations comprises sending the document via electronic mail.

10. The document workflow server application of claim 7, further configured to store the document to a storage repository.

11. The document workflow server application of claim 10, wherein the storage repository comprises a third-party cloud service.

12. A document workflow client application comprising one or more instructions embodied in computer-readable media, the document workflow client application configured to, when executed by a processor of an imaging device:
receive from a user interface of the imaging device a user selection to perform a document service; and
in response to the user selection, communicate the user selection to a document workflow server communicatively coupled to the imaging device via the Internet, wherein communication of the user selection causes the document workflow server to perform the document service.

13. The document workflow client application of claim 12, wherein the user selection is a user selection to perform a document search and communication of the user selection causes the document workflow server to:
perform a federated document search among multiple storage repositories; and
communicate search results to the imaging device.

14. The document workflow client application of claim 13, wherein the multiple storage repositories comprise at least one third-party cloud service.

15. The document workflow client application of claim 13, further configured to:
display the search results to the user interface;
receive from the user interface a user selection of a document from the search results;
in response to the user selection of the document, communicate the user selection of the document to the document workflow server to cause the document workflow server to retrieve the document from a storage repository on which it is stored; and
receive the document from the document workflow server.

16. The document workflow client application of claim 12, wherein the user selection is a user selection to digitize a scanned document and communication of the user selection causes the document workflow server to:
receive the scanned document from the imaging device; and
perform one or more document enhancement operations on the document.

17. The document workflow client application of claim 16, wherein the one or more document enhancement operations comprises one or more of:
optical enhancement of the document;
optical character recognition of the document;
conversion of the document from a first file format in which it is created on the imaging device to a second file format; and
tagging the document with metadata.

18. The document workflow client application of claim 17, wherein:
the imaging device is not configured to send an electronic mail from the imaging device; and
the one or more document enhancement operations comprises sending the document via electronic mail.

19. The document workflow client application of claim 16, wherein communication of the user selection further causes the document workflow server to store the document to a storage repository.

20. The document workflow client application of claim 19, wherein the storage repository comprises a third-party cloud service.
